(19) United States
(12) Patent Application Publication
(10) Pub. No.: US 2005/0114180 A1
(43) Pub. Date: May 26, 2005

(54) System and method for providing potential problem solutions to a service provider

(76) Inventors: Lawrence E. Ploetz, Brookfield, WI (US); James F. Kohli, Waukesha, WI (US); Tarun K. Shukla, Katni (IN)

Correspondence Address: Patrick S. Yoder;FLETCHER YODER, P.O. Box 692289, Houston, TX, 77269-2289, US

(21) Appl. No.: 10/723,687

(22) Filed: Nov. 26, 2003

(51) Int. Cl. G06F 17/60

(52) U.S. Cl. 705/2

(57) ABSTRACT

A system and method of identifying at least one potential solution to a problem associated with a remote medical device. The technique comprises automatically sending medical device data automatically to a service center. The service center has a database containing historic data for the medical device and a database containing potential solutions to a problem associated with at least one remote medical device. The technique comprises automatically searching the historic data database for historic data for the medical device using the medical device data. The technique comprises using the historic data found as a result of the search of the historic data database to automatically search the database of potential solutions. The technique also comprises sending the at least one potential problem solution found as a result of the search of the problem solution database from the service center to a service provider via a communications network.

### BACKGROUND OF THE INVENTION

The present invention relates generally to field of electronic device operation and maintenance. More particularly, the invention relates to techniques for storing solutions to medical device problems on a network and facilitating access to the problem solutions.

There are many different electronic devices available for learning about and treating patient conditions in the medical field. Over recent decades, more sophisticated systems have been developed that include various types of electrical data acquisition which detect and record the operation of systems of the body and, to some extent, the response of such systems to situations and stimuli. Even more sophisticated systems have been developed that provide images of the body, including internal features which could only be viewed and analyzed through surgical intervention before their development, and which permit viewing and analysis of other features and functions which could not have been seen in any other manner. All of these techniques have added to the vast array of resources available to physicians, and have greatly improved the quality of medical care.

However, medical devices, such as medical imaging systems, are complex. The complexity of the medical devices makes identifying and correcting problems with the devices difficult and time-consuming. Therefore, a need exists for a technique to facilitate the identification of solutions to problems associated with an electronic device, such as a medical information system.

### BRIEF DESCRIPTION OF THE INVENTION

A system and method of identifying at least one potential solution to a problem associated with a remote medical device. The technique comprises automatically sending medical device data automatically to a service center. The service center has a database containing historic data for the medical device and a database containing potential solutions to a problem associated with at least one remote medical device. The technique comprises automatically searching the historic data database for historic data for the medical device using the medical device data. The technique comprises using the historic data found as a result of the search of the historic data database to automatically search the database of potential solutions. The technique also comprises sending the at least one potential problem solution found as a result of the search of the problem solution database from the service center to a service provider via a communications network.

### BRIEF DESCRIPTION OF THE DRAWINGS

The foregoing and other advantages and features of the invention will become apparent upon reading the following detailed description and upon reference to the drawings in which:

FIG. 1 is a general diagrammatical representation of a medical information system, in accordance with an exemplary embodiment of the present invention;

FIG. 2 is block diagram of a process for facilitating the performance of a service on a medical device by providing a service provider with a potential solution to a problem, in accordance with an exemplary embodiment of the present invention;

FIG. 3 is a representation of a list of potential solutions to a problem associated with a medical device provided electronically to a service provider, in accordance with an exemplary embodiment of the present invention;

FIG. 4 is a representation of a potential solution to a problem associated with a medical device provided electronically to a service provider, in accordance with an exemplary embodiment of the present invention;

FIG. 5 is a representation of an electronic message board for a medical device, in accordance with an exemplary embodiment of the present invention;

FIG. 6 is block diagram of a process for facilitating the performance of a manual search of a database for a potential solution to a problem associated with a medical device, in accordance with an exemplary embodiment of the present invention;

FIG. 7 is a representation of a search browser to enable a service provider to manually search for a potential solution to a problem associated with a medical device, in accordance with an exemplary embodiment of the present invention; and

FIG. 8 is a representation of a list of potential solutions to a problem associated with a medical device produced as a result of using the search browser illustrated in FIG. 7.

### DETAILED DESCRIPTION OF SPECIFIC EMBODIMENTS

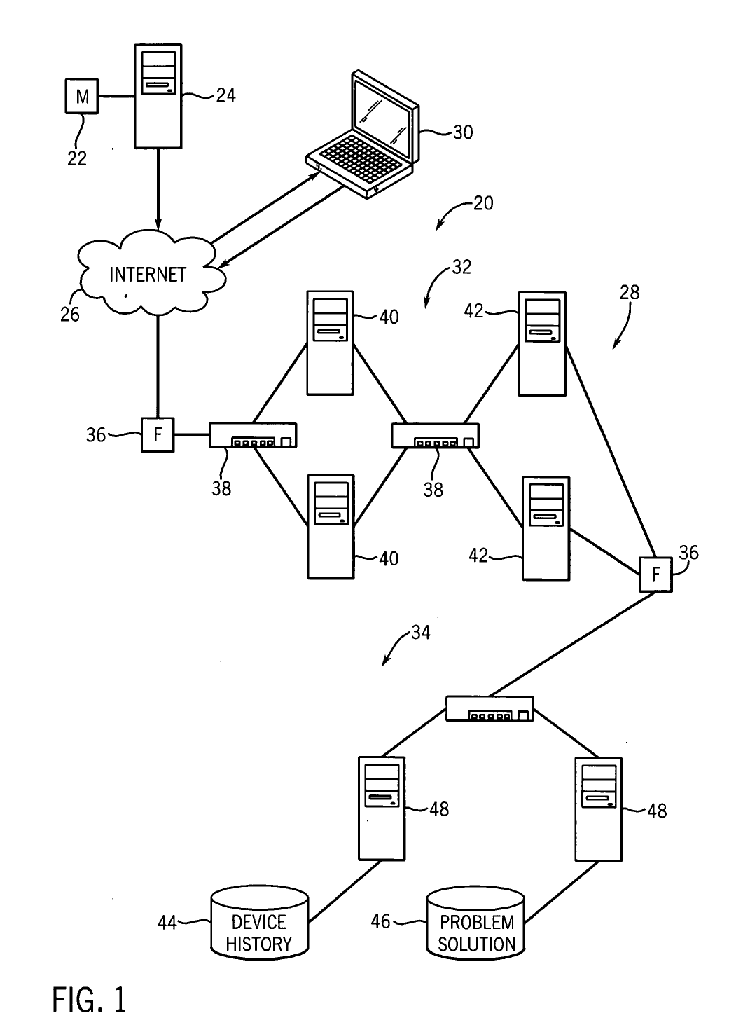

Referring generally to FIG. 1, a medical information system 20 is illustrated. However, the present techniques are applicable to other types of systems. In the illustrated embodiment, the medical information system 20 comprises a medical imaging system 22 that is connected by a computer 24 by a network 26, such as the network 26. The medical information system 20 also comprises a central computing system 28 that is coupled to the medical imaging system 22 via the network 26. However, the medical imaging system 22 may be connected directly to the network 26. The central computing system 28 is used as a service center to enable users to identify and correct problems associated with the medical imaging system 22.

In the illustrated device, a remote device 30 is coupled to the medical imaging system 22 and the central computing system 28 via the network 26. The network 26 enables a user to access both the central computing system 28 and the medical imaging system 22. In addition, the network 26 enables the central computing system 28 to access the medical imaging system 22, and vice versa.

The central computing system 28 is operable to store and process data to facilitate finding a solution to a problem associated with the medical imaging system 22. For example, a user may use the remote device 30 to access the central computing system 28 to find a solution to correct a medical imaging system 22 problem. The user may then use the remote device 30 to access the medical imaging system 22 to perform the corrective measure identified in the solution provided by the central computing system 28.

The central computing system 28 comprises an application server system 32 and a database server system 34 that contains various types of medical imaging system data for a plurality of different modalities of medical imaging systems. The application server system 32 has programming applications that instruct the system 32 to process data from the database server system 34, the medical imaging system 22, and the remote device 30. The application server system 32 comprises firewalls 36 and hubs 38. In addition, the application server system 32 comprises a plurality of load balancers 40 and web servers 42. The load balancers 40 balance the data loads to and from the web servers 42. The web servers 42 store and execute the programming applications that enable the application server system 32 to process the medical imaging data to provide one or more potential solutions to a medical information system problem. The database server system 34 comprises a device history database 44 and a problem solution database 46. The device history database is coupled by a server 48 to a hub 38. In addition, the problem solution database 46 is coupled by a server 48 to the hub 38.

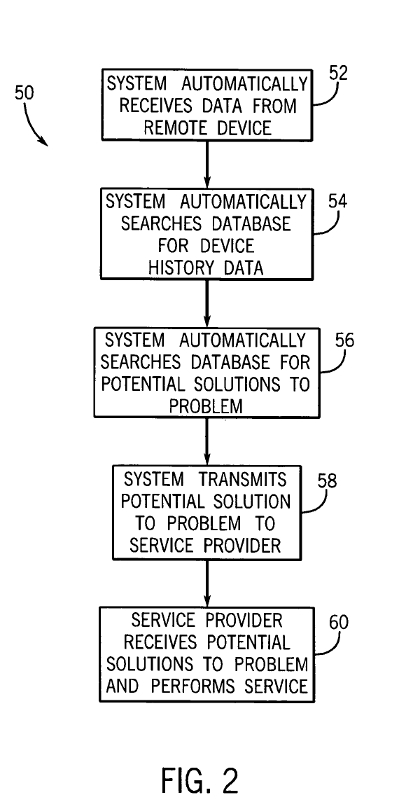

Referring generally to FIGS. 1 and 2, a method of automatically generating a list of potential solutions to a medical imaging system problem using the system 20 of FIG. 1 is represented generally in FIG. 2 by reference numeral 50. In the illustrated embodiment, the medical information system 20 automatically receives data corresponding to the medical imaging system 22, as represented generally by block 52. The data is specific to the medical imaging system 22. However, the data may be provided from the medical imaging system 22 or the remote device 30. For example, the data may be specific operational parameters for the medical imaging system. In addition, the data may be a request for service containing medical imaging system data, such as the model number of the medical imaging system 22. The central computing system 28 may also receive an indication of a problem from the medical imaging system computer 24 or the remote device 30.

The application server system 32 has programming applications that direct the application server system 32 to automatically search the device history database 44 for device history data corresponding to the specific medical imaging system 22 that was received automatically by the central computing system 28, as represented generally by block 54. The device history data may be previous service data, previous part replacement data for the medical imaging system, the model number of the medical imaging system, and many other types of historic data related to the specific medical imaging system or class of medical imaging systems.

The application server system 32 also has programming instructions that direct the application server system 32 to automatically query the problem solution database 46 using the device history data and/or the specific medical imaging system data, as represented by block 56. The problem solution database 46 comprises potential solutions to problems associated with a plurality of different systems. The device history data and/or the specific medical imaging system data enables the system 28 to filter the plurality of potential solutions to those potential solutions most relevant to the specific medical imaging system and the specific problem.

The system then automatically generates a list of potential solutions based on the query and transmits the list of potential solutions to a service provider, as represented by block 58. The list of potential solutions may contain a single solution. The list of potential solutions may be transmitted to a user via the network 26. The list of potential solutions may be received at the remote device 30, the medical imaging system computer 24, or at some other location.

Finally, the service provider receives the potential solution to a medical imaging system problem and services the medical imaging system to correct a problem, as represented by block 60. The list of potential solutions may be used by the service provider to develop a plan to correct the problem.

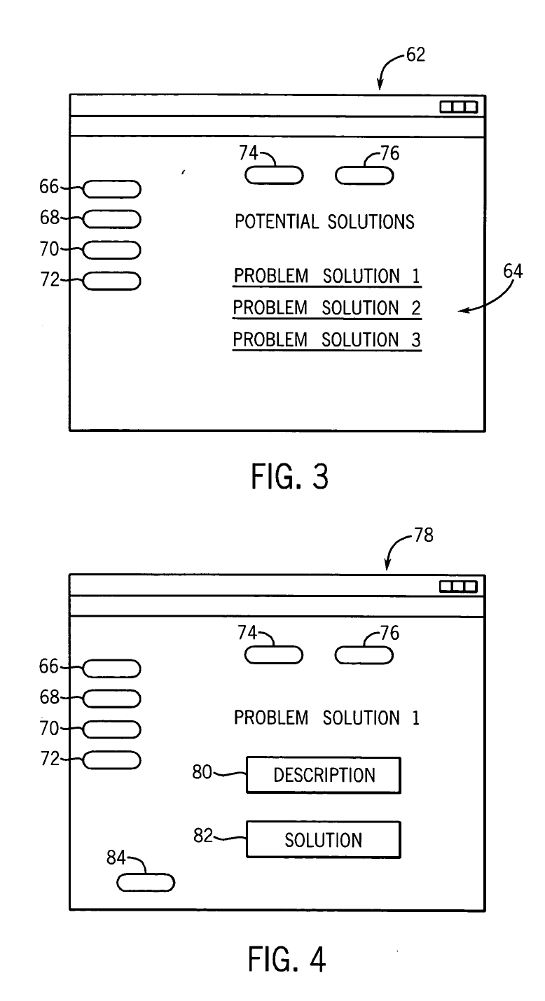

Referring generally to FIG. 3, a browser 62 for displaying a list of potential solutions on a computer display is illustrated. The browser 62 that may be viewed on the remote device 30, the medical imaging system computer 24, or some other device. The list of potential solutions is represented by a series of links 64. The title of the link may indicate relevant information, such as a description of the problem, the description of the solution, the modality of the device, etc. By activating the link, the user is directed to a browser window that provides the solution. Many different types of problem solutions may be provided. The solution may be an instruction for correcting the problem. The solution may be a program to be downloaded to the medical imaging system 22 or the medical imaging system computer 24. In the illustrated embodiment, the list of potential solutions is prioritized. The list of potential solutions may be prioritized based on a number of factors.

The illustrated browser 62 has a number of virtual buttons to enable a user to initiate the performance of various tasks. For example, the illustrated browser 62 has an application self-help button 66 to enable a user to direct a manual search of the problem solution database for a solution to a problem. The application self-help button 66 also may provide a user with the answers to frequently asked questions. The illustrated browser 62 has a message button 68 that enables a user to access messages sent by the central computing system 28 or the medical imaging system computer 24 to the service provider. For example, the list of potential problem solutions may be provided to the user via a message sent from the central computing system. In addition, the illustrated browser 62 has a contact button 70 that provides contact information for the medical imaging system vendor, such as a telephone number or an email address, when activated. The browser 62 also has a community button 72 that provides the user with access to information from other users. In addition, the window 62 has a button 74 that produces a list of previously asked questions when activated. A virtual button 76 also is provided to enable a user activate a program to enable the service provider perform a manual search of the problem solution database 46.

Referring generally to FIG. 4, a problem solution window 78 is illustrated. Activating one of the links 64 illustrated in FIG. 3 accesses the window. The problem solution window 78 provides a solution description text box 80 that contains a description of the problem and certain applicability information, such as the product or products for which the solution is applicable. The window 78 also comprises a problem resolution text block 82. The resolution text block 82 provides a specific solution for a specific medical imaging system problem. The window 78 also has a virtual button 84 that directs the system 20 to save the potential solution for access later without having to perform a second search for the problem solution.

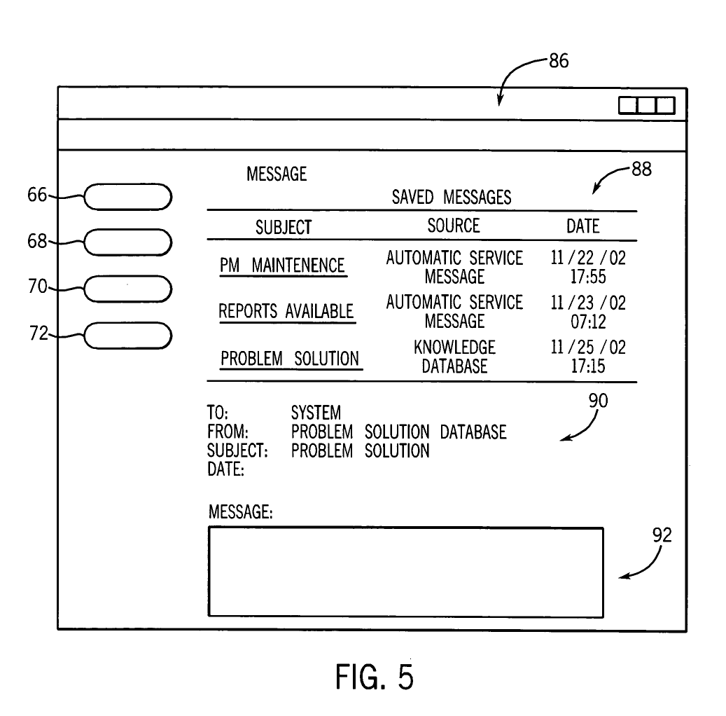

Referring generally to FIG. 5, a message window 86 displaying saved messages accessible by activating the message button 68 is illustrated. The message window 86 is accessible from the medical imaging device computer 24 or the remote device 39. The window 86 has a first portion 88 that includes a list of messages stored in the system. In the illustrated embodiment, the subject matter of each message is provided, as well as the source of the message and the time that the message was received. The message window 86 has a second portion 90 that contains address information for the e-mail message. The message window 86 has a text box 92 that displays the text of the problem solution. In this example, each of the messages in the list of messages is a link to a message. When the link is activated, the text of the message is displayed in the text box 92.

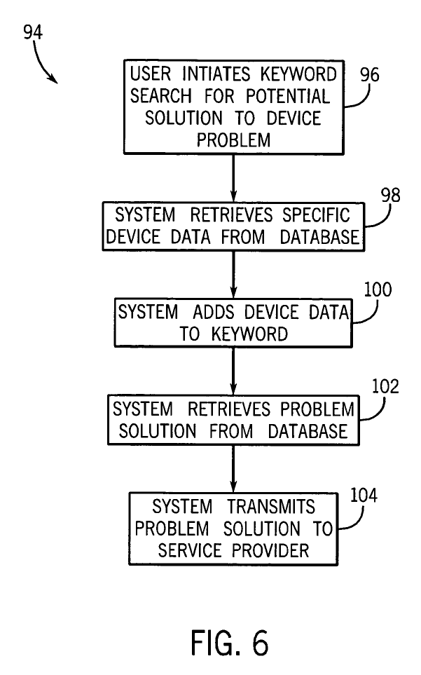

As noted above, the system 20 also enables a service provider to perform a manual search of the problem solution database 46. Referring generally to FIG. 6, a process to facilitate a manual search for a solution to a medical imaging system problem is illustrated. The process is represented generally by reference numeral 94. The illustrated process 94 begins with a user initiating a keyword search for a solution to a medical imaging system problem using a search program, as represented by block 96. The browser is an application stored in the application server system 32 and accessible from the remote device 30 or the medical device system 24 via the network 26. The search program is operable to query the problem solution database 46. The keyword entered by the user may be selected from among many possible words that would facilitate the identification of the solution to the problem.

The search program then retrieves data specific to the medical imaging system and adds the data to the keyword, or keywords, entered by the service provider before performing the query for potential solutions in the problem solution database, as represented by block 100. For example, the specific data may be the modality or the model number of the medical imaging system. The medical imaging system data may be retrieved in a number of different ways. For example, a user may log into the program using a user name, or some other identifier, specific to the medical imaging system. The program may then search a device history database to find data corresponding to the specific medical imaging system, such as the modality and the model number. However, other data and methods may be used.

The program searches the problem solution database using the keyword or keywords provided by a service provider and the keywords attached by the search program, as represented by block 102. The potential solutions may be prioritized based on a number of factors. For example, the problem solution having the greatest number of occurrences of the keywords in the problem solution may be listed first in a list.

The results of the query of the problem solution database 46 are then transmitted to the service provider via the network 26, as represented by block 104. If the service provider decides to continue searching, the service provider may return to the search program browser.

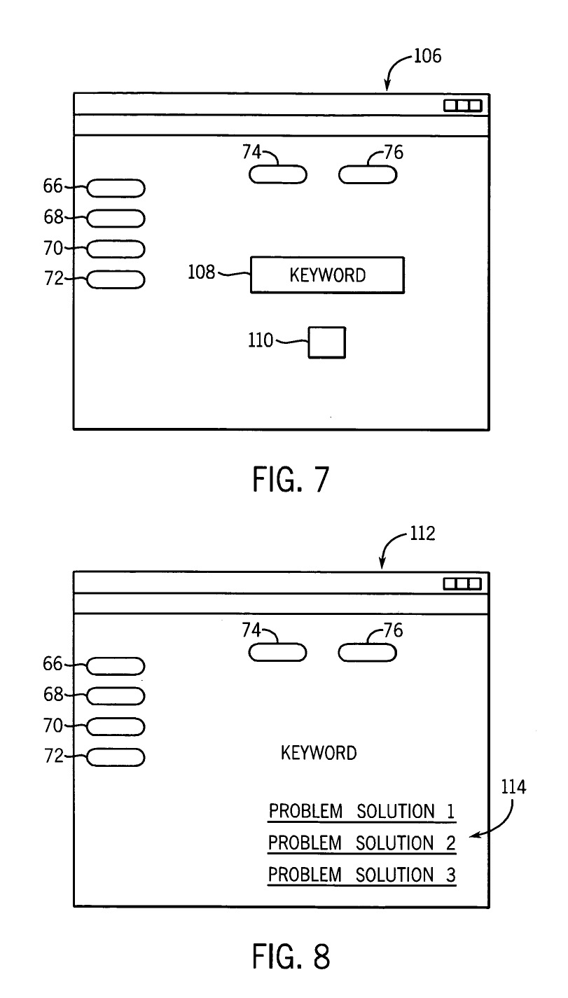

Referring generally to FIG. 7, an embodiment of a search window 106 of a browser coupled to the application server system 32 of FIG. 2 is illustrated. The application server system 32 is operable to facilitate a manual search for a solution to a medical information system device, as described above in FIG. 5. In the illustrated embodiment, the search window 106 has a keyword entry box 108 and a search activation button 110. When the search activation button 110 is activated, the application service provider stored in the application server system 32 retrieves specific medical imaging system data from the device history database 44 illustrated in FIG. 2 and attaches the data to the keyword provided in the keyword entry box 108 to narrow the search for a problem solution. The application service provider then performs a search of the problem solution database 46. The results of the search are then transmitted to the user in a new browser window.

Referring generally to FIG. 8, an embodiment of a search results window 112 is illustrated. The results window 112 provides a list of links 114 to problem solutions corresponding to the keyword or keywords provided and the specific medical imaging system data. When a link is activated, a user is redirected to a browser window containing a specific problem solution, such as the problem solution illustrated in FIG. 4. The illustrated results window 112 also provides a text box illustrating the keyword or keywords provided by the user.

The embodiments described above provide a system and method to facilitate the identification of solutions to problems associated with a medical imaging system. The system provides means for providing a potential solution to a problem associated However, these techniques are applicable to other medical devices, as well as electronic devices in general.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A system for automatically providing a user with at least one potential solution to a problem associated with a medical device, comprising:
a server system operable to receive data from a medical device, the server system comprising:
a first database containing historic data for a plurality of medical devices related to the medical device;
a second database containing a plurality of solutions to problems associated with the plurality of medical devices; and
an application service provider that directs the server system to use the data from the medical device to automatically search the first database for historic data for the medical device and to automatically search the second database for at least one potential solution to a problem associated with the medical device using the data from the medical device and the historic data for the medical device.

2. The system as recited in claim 1, wherein the application service provider directs the server system to use the data from the medical device to automatically search the first database for keywords associated with the medical device.

3. The system as recited in claim 1, wherein the application service provider directs the server system to automatically search the second database for at least one potential solution to a problem associated with the medical device using the keywords obtained from the first database and the data from the medical device.

4. The system as recited in claim 3, wherein the application service provider directs the server system to automatically perform the searches of the first database and the second database in response to a service request transmitted to the server system.

5. The system as recited in claim 1, wherein the service request is transmitted to the server system from the medical device.

6. The system as recited in claim 5, wherein the server system transmits the at least one potential solution to a problem associated with the medical device to the medical device.

7. The system as recited in claim 1, wherein the service request is transmitted to the server system from a remote computer.

8. The system as recited in claim 7, wherein the server system transmits the at least one potential solution to a problem associated with the medical device to the remote computer.

9. A method of identifying at least one potential solution to a problem associated with a remote medical device, comprising:
sending data from a remote medical device to a service center comprising a database of potential solutions to a problem associated with at least one remote medical device;
automatically searching the database of potential solutions for at least one potential solution to a problem associated with the remote medical device in response to one of a request for service and the data from the remote medical device; and
sending the at least one potential solution to a problem associated with the remote medical device from the service center to a service provider via a communications network.

10. The method as recited in claim 9, wherein sending a request for service for service of a remote medical device comprises sending data to enable the service center to identify the remote medical device from a plurality of remote medical devices.

11. The method as recited in claim 10, wherein automatically searching the database of potential solutions comprises searching a first database comprising remote medical device data for keywords associated with the remote medical device for use in searching the database of potential solutions for the at least one potential solution to a problem associated with the remote medical device.

12. The method as recited in claim 9, wherein sending the at least one potential solution to a problem associated with the remote medical device from the service center to a service provider via a communications network comprises sending an e-mail message containing the at least one potential solution to a problem associated with the remote medical device to the service provider.

13. A system for identifying at least one potential solution to a problem associated with a remote medical device, comprising:
means for sending data from a remote medical device to a service center;
means for automatically searching a database of potential solutions for at least one potential solution to a problem associated with the remote medical device; and
means for sending the at least one potential solution to a problem associated with the remote medical device from the service center to a service provider via a communications network.

14. A system, comprising:
a processor-based device; and
programming instructions to enable the processor-based device to automatically perform a search of a database of solutions to medical device problems in response to a service request from the remote medical device.

15. The system as recited in claim 14, comprising:
programming instructions to enable the processor-based device to automatically perform a search of a database of medical device data in response to the service request from the remote medical device.

16. The system as recited in claim 15, comprising:
programming instructions to enable the processor-based device to transmit results of the search of the database of solutions to medical device problems to a service provider via the network.

17. A computer program stored in a tangible medium, comprising:
programming instructions to enable a processor-based device to automatically perform a search of a database of solutions to problems associated with a medical device in response to at least one of data from the medical device and a service request.

18. A system for providing a user with at least one potential solution to a problem associated with a medical device, comprising:
a server system operable to receive data from a remote device, the server system comprising:
a first database containing data for each of a plurality of medical devices;
a second database containing a plurality of solutions to problems associated with the plurality of medical devices; and
programming instructions to enable a user to perform a keyword search of the second database using a keyword provided by the user to identify at least one solution to a problem associated with the medical device,
wherein the server system receives the data from the remote device and searches the first database for data associated with the medical device and searches the second database using the data from the first database as a keyword along with the at least one keyword provided by the user.

19. The system as recited in claim 18, comprising programming instructions to enable the server system to send results of the keyword search of the second database to a service provider via the network.

20. The system as recited in claim 19, comprising programming instructions to enable the service provider to store the results of the keyword search of the second database at the medical device.

21. A method of identifying at least one solution to a problem associated with a specific medical device, comprising:
providing the system with data to enable the system to identify a category of medical devices that includes the specific medical device;
directing the system to automatically retrieve data from a database for the device from a database containing historical data for a plurality of devices using the device specific data; and
automatically searching for at least one solution to a problem associated with the device from a database containing solutions to a plurality of problems associated with the device.
